(19) United States
(12) Patent Application Publication
(10) Pub. No.: US 2024/0231579 A1
(43) Pub. Date: Jul. 11, 2024

(54) METHOD, APPARATUS, ELECTRONIC DEVICE AND STORAGE MEDIA FOR INFORMATION PROCESSING

(71) Applicant: Beijing Zitiao Network Technology Co., Ltd., Beijing (CN)

(72) Inventors: Bo LI, Beijing (CN); Ziqing ZHOU, Beijing (CN)

(21) Appl. No.: 18/614,323

(22) Filed: Mar. 22, 2024

(30) Foreign Application Priority Data
Mar. 22, 2023 (CN) 202310287796.2

(51) Int. Cl. G06F 3/0484; G06F 3/0482

(52) U.S. Cl. CPC G06F 3/0484; G06F 3/0482

(57) ABSTRACT

The application provides a method for information processing, an apparatus for information processing, an electronic device and computer-readable storage medium. The method includes: in response to a first predetermined operation triggered by a user in a user interface of a first session, determining a first set of information and establishing an association relationship between the first session and the first set of information; and providing, in the first session, a business function corresponding to the first set of information based on the first set of information. According to the application, an operable association relationship can be established between a session and an information set, which facilitates users to simultaneously operate information during a session, provides corresponding business functions and facilitates information processing.

### CROSS-REFERENCE

This application claims priority to Chinese patent application Ser. No. 20/231,0287796.2, filed on Mar. 22, 2023 and entitled “METHOD, APPARATUS, ELECTRONIC DEVICE AND STORAGE MEDIA FOR INFORMATION PROCESSING”, the entirety of which is incorporated herein by reference.

### FIELD

This application relates to the field of the Internet, and in particular a method for information processing, an apparatus for information processing, an electronic device and computer-readable storage medium.

### BACKGROUND

Internet products include processing and operating technologies for various online and offline information. These information processing technologies often have the problem of being separated from each other and unable to connect with each other. For example, users' daily collaboration and communication are usually carried out in instant messaging sessions. Session page is also a page where users stay at work, and various business data are usually in other business systems. If users need to access business data and leave the session, accessing from the entrance of the business system, and the operation is cumbersome.

### SUMMARY

To this end, this application is committed to providing a method for information processing, an apparatus for information processing, an electronic device and a computer-readable storage medium, which can facilitate a mutual connection between a session and a set of information, so that users can conveniently operate or utilize the set of information during sessions.

In one aspect, the present application provides a method for information processing. The method includes in response to a first predetermined operation triggered by a user in a user interface of a first session, determining a first set of information and establishing an association relationship between the first session and the first set of information; and providing, in the first session, a business function corresponding to the first set of information based on the first set of information.

In another aspect, the present application provides an apparatus for information processing. The apparatus includes a determining module configured to, in response to a first predetermined operation triggered by a user in a user interface of a first session, determine a first set of information and establishing an association relationship between the first session and the first set of information; and a business module configured to provide, in the first session, a business function corresponding to the first set of information based on the first set of information.

In still another aspect, this application provides a computer-readable storage medium on which a computer program is stored. When the computer program is executed in a computer, the computer is caused to perform the above method for information processing.

In yet another aspect, this application provides an electronic device including a memory and a processor, the memory storing executable code that when executed by the processor, implementing the above method for information processing.

### BRIEF DESCRIPTION OF THE DRAWINGS

The detailed description of this application is described in detail with reference to the accompanying drawings below, wherein:

FIG. 1 shows a schematic flow chart of a method for information processing according to an embodiment of the present application;

FIG. 2 shows a schematic diagram of a session menu according to the embodiment in FIG. 1;

FIG. 3 shows a schematic diagram of a query result display style according to the embodiment in FIG. 1;

FIG. 4 shows a schematic flow chart of a method for information processing according to another embodiment of the present application;

FIG. 5 shows a schematic structural diagram of an apparatus for information processing according to an embodiment of the present application; and

FIG. 6 shows a schematic structural diagram of an electronic device according to an embodiment of the present application.

### DETAILED DESCRIPTION

The technical solutions provided in this specification will be further described in detail below in conjunction with the accompanying drawings and embodiments. It can be understood that the specific embodiments described here are only used to explain the relevant invention, but not to limit the invention. It should also be noted that, for convenience of description, only the parts related to the invention are shown in the drawings. It should be noted that, as long as there is no conflict, the embodiments in this specification and the features in the embodiments can be combined with each other.

In this article, the terms “a”, “an” and other similar words are not intended to indicate that there is only one of the things described, but rather that the description is directed to only one of the things, which may have one or more. In this article, the terms “comprising”, “includes” and other similar words are intended to indicate logical interrelationships and may not be regarded as indicating spatial structural relationships. For example, “A includes B” is intended to mean that B belongs to A logically, but does not mean that B is located inside A spatially. In addition, the terms “contain,” “include” and other similar words are to be considered open rather than exclusive. For example, “A includes B” is intended to mean that B belongs to A, but B does not necessarily constitute all of A. A may also include other elements such as C, D, and E.

In this document, the terms “first”, “second” and other similar words are not intended to imply any order, quantity or importance, but are merely used to distinguish different elements. In this article, the terms “embodiment”, “this embodiment”, “an embodiment” and “one embodiment” do not mean that the relevant description applies only to one specific embodiment, but that the description may also apply to another one or more embodiments. Those skilled in the art will understand that in this article, any description of a certain embodiment can be replaced, combined or otherwise combined with the relevant description of one or more embodiments. New embodiments produced by the replacing, combining or otherwise combining can be easily thought of by those skilled in the art, and fall within the protection scope of this application.

In various embodiments of this application, information processing may refer to various processing and consumption activities for information. For example, information processing may refer to processing for user input information, processing for information stored in a storage medium, processing for information that is being calculated by a computing element, or a combination of various processing methods. A typical scenario of information processing is the processing for various online and offline information by Internet products, including collection, calculation, rendering and sending of the information. For example, information processing in this application may refer to the processing of various information that can be achieved by online collaboration software, communication software, or other Internet software products that can be used for mutual interaction, communication, and collaboration between different users.

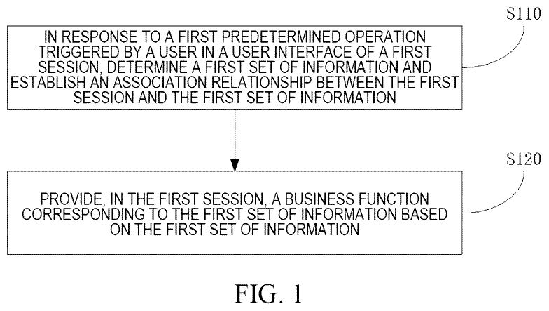

FIG. 1 shows a schematic flowchart of a method for information processing according to an embodiment of the present application.

According to this embodiment, the method for information processing comprises steps S110 and S120, which will be described in detail below.

At S110, in response to a first predetermined operation triggered by a user in a user interface of a first session, a first set of information is determined and an association relationship between the first session and the first set of information is established.

In this embodiment, the session may refer to a communication exchange scenario between two or more users for information transfer and message sending/receiving through a network. For example, the session may refer to a single chat session or a group chat session in instant messaging applications, as well as a session provided in enterprise collaboration applications, social platform applications, and e-commerce platform applications for two or more users to communicate instantly. The user interface of the session may refer to an interface presented for users in the session to perform input, output, or other operations by software or devices that are used to achieve session functions. For example, in some embodiments, the user interface of the session refers to an interface that provides message sending and receiving functions.

In this embodiment, the predetermined operation may refer to a specific operation that is preset to achieve a certain function. The predetermined aspect of the predetermined operation may be an operation mode, operation object, operation body, or any other aspect related to the operation.

In this embodiment, the first predetermined operation triggered by the user in the user interface of the first session may refer to an operation behavior, which has been preset in some aspects, performed by the user using the session function or software on the interface used to realize the input/output of session information. For example, the first predetermined operation triggered by the user in the user interface of the first session may refer to the click, typing, drawing, voice, gesture and other operations performed by the user of the chat software on the chat interface. Other implementations are also conceivable.

In this embodiment, the set of information may refer to a combination of a plurality of pieces of information, and its expression may be a specific document, file, information segment, data set, database, table or software, etc.

At S120, in the first session, a business function corresponding to the first set of information is provided based on the first set of information.

In this embodiment, the business function may refer to a function used to realize certain business. The business mentioned here may refer to the operational activities which various business entities (companies, organizations, institutions, etc.) in the real world need to carry out or various means required to maintain such operational activities. For example, the business function may refer to creating session menus, knowledge base queries, management functions, attendance functions, information summary functions, form filling functions, team collaboration functions, progress monitoring functions, etc.

In this embodiment, providing the business function corresponding to the first set of information in the first session may refer to such a business function that needs to use or be based on certain information. For example, the information summary function needs to summarize the information of each user, the team collaboration function needs to share collaboration content and progress among various users, and the management function needs to collect and record the daily behavior data or work information of each management object or user, etc. Providing the business function corresponding to the first set of information in the first session means in view of different information required by the business function, providing various business functions corresponding to the first set of information in the first session, that is, various business functions which the first set of information can support.

According to this embodiment, the method for information processing triggers to establish an association between the session and the set of information based on the user's specific operation, facilitating users who communicate through the session function to call the set of information promptly and quickly and realizing the integration of the use of the session and the set of information. At the same time, by providing the business function corresponding to the set of information in the session, the session function and the business function can be connected, which improves work efficiency and reduces collaboration costs. Users can easily add business functions to the session. This provides convenience for users whose main work scenario is conversation, allowing them to easily obtain/process business data in the group and facilitating communication of business data within the group.

As an example, the specific implementation of determining the first set of information in response to the first predetermined operation triggered by the user in the user interface of the first session may be: in response to the first predetermined operation triggered by the user in the user interface of the first session, determining a target object pointed to by the first predetermined operation, and determining a set of information associated with the target object as the first set of information.

According to this example, by setting the target object, the predetermined operation has a clear pointing object, which facilitates the determination and binding of the set of information, and at the same time gives the user a clear prompt to inform them that the corresponding set of information and corresponding business function are about to be enabled.

In this embodiment, the target object may refer to an object which is directly or indirectly started, triggered, called or used by the first predetermined operation. This object may be an object with a certain appearance in the interface, or it may refer to a certain storage space stored in a storage medium or a certain functional module in a computing element. For example, the target object may refer to buttons, function options, text, graphics, color blocks, auxiliary robots and the like in the user interface.

In this embodiment, the set of information associated with the target object may refer to such a set of information that is bound to the target object through specific links, references or other techniques. When the target object is triggered by a predetermined operation, the set of information can be determined based on the binding relationship between the target object and the set of information, thereby realizing the operation, utilization and editing of the set of information.

As one example, the first predetermined operation comprises: an operation of adding a predetermined chat robot as a member of the first session; the target object comprises the predetermined chat robot.

According to this example, by using the chat robot as the target object, specific sets of information and business functions may be introduced through operations such as adding and deleting session members that are familiar to users. As a session member, the chat robot may play both the role of a session member and the role of an operating button or information prompt, which is a friendly way of interaction.

In this embodiment, the chat robot may refer to a virtual chat subject that may join as a member of a chat session to perform various automated functions.

As another example, the first predetermined operation comprises: triggering a predetermined control in the first session; the target object comprises the predetermined control.

According to this example, by using the predetermined control as the target object, the target object may be started in a simple and intuitive way. Controls are widely used in ordinary Internet products. Operating and interacting with controls is the most familiar interaction method for Internet product users. The technical solution of using the predetermined control to enable sets of information and business functions is also a low cost and easy to implement.

In this embodiment, the predetermined control may refer to a certain symbol, button, graphic or component used for control or manipulation in the session interface.

In this embodiment, establishing the association between the first session and the first set of information may refer to functionally binding the first session to the first set of information through a predetermined operation, so that the first set of information may be utilized and called to a certain extent in the first session.

As an example, the specific implementation of establishing the association between the first session and the first set of information may be: saving the association information in a predetermined storage location, e.g., saving the association information between the first session and the first set of information in a first sub-table of a first online table.

According to this example, saving the association information between the session and the set of information in the sub-table of the online table may be storing, modifying and displaying the association information in a simple way. Tables are a commonly used form of structured data, and recording information in tables is easy to implement and saves storage space.

In this embodiment, online tables may refer to tables used to achieve online functions such as online editing, online storage, and online entry. In some embodiments, the online table can be an ordinary online table or a multidimensional table (the columns of the multidimensional table may be set to a fixed format, for example, a certain column may be set to only input data in date format). The online table may contain the set of information, or may contain other contents besides the aforementioned set of information, such as the association between the sessions and the information collection. The set of information may be at least part of the data stored in the online table. For example, the set of information may be one or more sub-tables in the online table, or the set of information may also be data in a specified row or column in one or more sub-tables in the online table.

In this embodiment, storing the association information between the first session and the first set of information in the first sub-table of the first online table may refer to recording the binding relationship between the first session and the first set of information in a sub-table of the first online table. For example, the first session and the first set of information may be recorded in the same row of the sub-table to represent the association between them. Other ways of expressing the association are also conceivable.

As an example, the first set of information comprises a plurality of information sub-sets corresponding to a plurality of business functions. At this point, the specific implementation of providing the business function corresponding to the first set of information in the first session may be: providing a plurality of business functions corresponding to the plurality of information sub-sets in the first session.

According to this example, the set of information may correspond to one or more business functions. By corresponding the set of information to a plurality of business functions, the utilization and richness of the set of information are greatly expanded, the efficiency of information processing and utilization can be improved, and more diverse application scenarios can be provided.

In this embodiment, the information sub-set may refer to a plurality of smaller sets of information included in the set of information, and the information contained in the information sub-set may be a subset of the set of information. The plurality of information sub-sets corresponding to the plurality of business functions may refer to that each information sub-set corresponds to a business function. These business functions may be the same or similar functions, or they may be completely different business functions. The sets of information required by these business functions have certain similarities or unity, so these sets of information are organized and managed as information sub-sets in a large set of information.

As an example, the first set of information comprises session menu configuration information. At this point, the specific implementation of providing the business function corresponding to the first set of information in the first session based on the first set of information may be: creating a session menu in the first session according to the session menu configuration information.

According to this example, setting a session menu in the session can facilitate session members to perform specified operations and facilitate the unification, standardization and collection of information. The session menu configuration information is stored through the set of information, so that the session application can easily set, edit and modify the session menu, which can enrich the use scope of the session application, expand the functional types of the session application and achieve high efficiency of information processing.

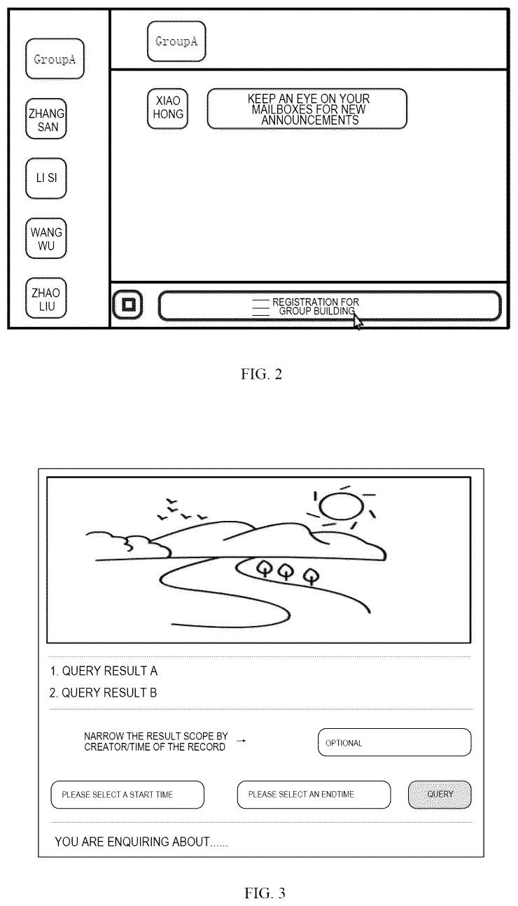

In this embodiment, the session menu may refer to an input box menu in the session interface, which allows the user to directly click on a specific content during the session without having to enter a specific content. FIG. 2 shows an example of a session menu, in which the “Team Building Registration” part is an option in the input box menu. After clicking this option, the user can enter the details page of the menu to perform registration click operations.

In this embodiment, the session menu configuration information may refer to pre-configured information about the options, format, level, operation objects and other aspects of the session menu and its characteristics.

As an example, in response to that the first set of information comprises the session menu configuration information, the first predetermined operation comprises: an operation for adding a predetermined chat robot as a member of the first session, and the method may further comprise: in response to deleting the predetermined chat robot from the first session, removing the session menu from the first session, and deleting the association relationship between the first session and the first information set.

According to this example, by adding and deleting the chat robot in the session, the session menu function can be introduced and deleted through the operation that is familiar to the user, and at the same time, each session member is given a clear prompt indicating whether the session menu function is currently available, or each session member is prompted to operate the session menu as required.

In this embodiment, session members may refer to all members or people in the session. A session member may be a person (user), or a software, application or functional module (such as a chat robot). Adding a session member may refer to an operation of adding a session member as a member who can post information or content in the session. Deleting a session member may refer to an operation that causes the session member to leave the session, or prevents the session member from posting or receiving any information in the session.

As an example, the method for information processing may further be performed as follows: in response to a first user adding the predetermined chat robot as a member of other session, creating a session menu in the other session, the other session being a session other than the target session; in response to a trigger operation of a second user on the created session menu, performing an execution step corresponding to the session menu, wherein the first user and the second user are both session members of the other session, and the first user and the second user are different users or the same user; the session menu created in the other session is different from the menu created in the target session.

In other words, users can not only create session menus in the current session, but also create session menus in other sessions. Not only users in the current session can operate the menu in the current session, but users in other sessions can also operate in other sessions at the same time. The user can create a plurality of menus across a plurality of sessions for use by a plurality of users.

As an example, after creating the session menu in the first session according to the session menu configuration information, the following may further be performed: in response to receiving an operation for modifying the menu configuration information, updating the session menu in the first session accordingly.

According to this example, the menu interface in the first session may be modified and operated by directly modifying the menu configuration information, thereby making it convenient for the user to edit the menu.

In some embodiments, the first set of information comprises a predetermined data set, and the providing a business function corresponding to the first set of information in the first session based on the first set of information comprises: providing a service for querying the predetermined data set in the first session.

According to this example, by providing data query services in the session application, users can easily find the data necessary to explain problems, display opinions, express information, understand the truth, etc. Users can query desired data without leaving the session interface, which improves operation efficiency and facilitates information circulation.

In this embodiment, the predetermined data set may refer to a predetermined data set to be queried by the user, which contains various data which the user may use and view. As an example, the first set of information comprises the predetermined data set. At this point, the specific implementation of providing a service for querying the predetermined data set in the first session may be: in response to the user inputting a message comprising a predetermined symbol and a query keyword in the first session, obtaining a query result matching the query keyword from the predetermined data set, and feeding back the query result into the first session.

According to this example, querying through predetermined symbols and keywords is a familiar operation method for Internet product users. Operating the query function in this way can reduce the user's learning cost and facilitate immediate use and switching of the query function.

In this embodiment, predetermined symbols may refer to symbols used to distinguish the text or information normally input by the user from the information to be input when the user wants to activate the query function. In an embodiment, the predetermined symbol may refer to the “@” symbol. In this embodiment, query keywords may refer to those words, numbers or symbols that can indicate the user's query purpose and are reflected in the data to be queried.

As an example, the method for information processing method may further be implemented in such a manner: in response to a predetermined information query request triggered by the user in the session, determining a set of information associated with the session; wherein the user is a session member of the session, and the set of information comprises out-of-session information; obtaining a query result from the set of information according to the information query request; displaying the query result in the session.

In this way, users may query information out of the session through the query function in the session. It should be noted that the set of information comprises information out of the session, that is, the query on the set of information in the present disclosure is different from the query on the message within the session. Information out of the session may include, but is not limited to, some business data which session members need to query in their daily work. These business data are usually stored in other systems other than the communication system where the session is located.

As an example, the specific implementation of determining a set of information associated with the session in response to a predetermined information query request triggered by the user in the session may be: determining an online data table associated with the predetermined information query request, and judging whether a predetermined permission of the online data table is turned onion; if the predetermined permission is turned on, obtaining a target identification, and searching for a sub-table corresponding to the target identification from the online data table as a set of information; if the predetermined permission is not turned on, obtaining permission configuration information of the session, and determining a sub-table in the data table corresponding to the session serves as a set of information based on the permission configuration information. In this embodiment, the target identification comprises the user's identification and the session's identification.

In this way, the user's query permissions can be set in advance to manage the query scope and avoid unnecessary information leakage.

As an example, the predetermined symbol comprises a symbol referring to a predetermined chat robot. Before providing a service for querying the predetermined data set in the first session, the method for information processing further comprises: adding the predetermined chat robot as a member of the first session, and wherein the method for information processing further comprises: in response to deleting the predetermined chat robot from the first session, deleting the association relationship between the first session and the first set of information.

According to this example, the query function is turned on and off by adding and deleting robots in the session, which can intuitively remind users and other members about the query function, and facilitate users to perform any related operations on the query function.

In this embodiment, symbols referring to a predetermined chat robot may refer to various characters, numbers, texts or graphics that are pre-designed to enable chat robots. Such symbols can be symbols that are not commonly used in daily chatting. In an embodiment, this symbol can be the “@” symbol.

As an example, the feeding back the query result into the first session comprises: displaying the query result to all session members in the first session; or displaying the query result to a portion of the session members in the first session, wherein the portion of the session members comprises the user and at least one further user; or displaying the query result only to the user in the first session.

According to this example, through settings, the user may set the query result to be visible to all members, part of members, and only themselves in the session, which facilitates the management and control of information about the query results and query steps, and prevents information that does not want to be made public from being disclosed.

As an example, the feeding back the query result into the first session comprises: obtaining display style configuration information of the query result corresponding to the first session; and sending a query feedback message comprising at least a portion of the query result in the first session based on the query result and the display style configuration information of the query result corresponding to the first session.

According to this example, by displaying query results based on style configuration information, users can have a richer and more flexible visual experience when viewing query results, and provide a more intelligent display effect.

In this embodiment, the query result display style may refer to the specific style or form used to display the query result, which may have various formats, graphics, text or various material combinations. In an embodiment, the query result display style may be in the form of a message card, as shown in FIG. 3. The display style configuration information of the query result may refer to the configuration information about the specific visual form of the display style, such as what kind of text and what kind of pictures the display style has, etc.

For example, the display style configuration information of the query result may be picture information, and the picture information comprises pictures displayed simultaneously with the query result. For another example, the display style configuration information of the query result may be remark information, and the remark information comprises source information of the query result.

As an example, the feeding back the query result into the first session comprises: sending a query response message in the first session, the query response message comprising an interactive control for further adjusting a query scope; and in response to the user's operation of adjusting the query scope based on the interactive control, obtaining the query result in the user-adjusted query scope and sending the query result in the first session.

According to this example, by setting interactive controls for users to perform selection operations, the query process can be accelerated, making it easier for users to obtain the information they want to query without having to set cumbersome query conditions. Through step-by-step interaction, the content that wants to be queried can be obtained quickly, which improves the query efficiency and accuracy.

In this embodiment, interactive controls may refer to controls used by users to interact with query results or query processes when querying. For example, the interactive control may be a plurality of data source options, and the query result may be output to the session interface based on the user's selection operations on the plurality of data source options. The query result is obtained from the data source selected by the user. For another example, if the query result comprises a plurality of query result items, the interactive control comprises alternatives corresponding to each of these query result items for the user to select.

As an example, the interactive control comprises: a data source selection control for selecting from a plurality of data sources, and/or a setting control of a filtering condition. The filtering condition comprises at least one of: a data record creator, a data record creation time, or a value of a field comprised in the data record.

According to this example, filtering query results based on data sources or filtering conditions is a common query operation requirement to users. By setting controls with this filtering function, the needs of most users in filtering query results can be met, thereby better improving the user experience of querying.

In this embodiment, the data source selection control may refer to a control through which the user may select a plurality of query results with different data sources according to the data source. The setting control of a filtering condition may refer to a control through which the user may set filter conditions for a plurality of query result items, so that unwanted query results are filtered out and the query result is made to better match the user's query needs.

As an example, if the first set of information comprises the session menu configuration information and the predetermined data set, the session menu created in the first session comprises a first menu item providing the user with an interface for inputting information to the predetermined data set.

According to this example, the session menu function and the data query function can be provided at the same time, which further enriches the application scenarios of the session application, facilitates users to implement session operations with various purposes, and further enhances the versatility and convenience of the method for information processing.

In this embodiment, the menu item can refer to an item in the menu which the user can select, such as a row of content in a column of menus. In this embodiment, the first menu item provides the user with an interface for inputting information to the predetermined data set, which may mean that the first menu item allows the user to input text, instructions or other information related to the information they want to query, so that the query function is implemented.

As an example, the first menu item is bound to an access address of the predetermined data set, and the first menu item outputs to the user a page for inputting information to the predetermined data set in response to the user accessing the first menu item.

According to this example, the menu item is bound to a data set, and the user may be guided to access a specific data set through simple point-and-click operations. In addition, displaying the information inputting page in the menu item can guide the user to implement convenient and fast information inputting operations, making it easier to realize the user's query needs.

In this embodiment, the first menu item is bound to the access address of the predetermined data set, so that the user can access the predetermined data set when clicking the first menu item, thereby allowing the predetermined data set to be queried. At the same time, the first menu item outputs to the user a page for inputting information, so that the user may input the keywords he wants to query, thereby facilitating the user to implement the query operation.

The method for information processing according to this embodiment may be performed by a workflow created based on an integration platform. The workflow may be understood as a data processing service that can perform corresponding data processing operations when run.

In this embodiment, the integration platform may refer to a software platform that supports application development and system integration operations in complex information environments. It can provide cross-application business process integration and closed loops without breaking the boundaries of existing applications. The integration platform is an effective support tool for enterprises to implement informatization projects. It can provide universal communication and information access services, so that application software functions do not depend on specific hardware systems, operating systems, network protocols and database management systems, and have good portability. The integration platform achieves user-friendly effects by providing a common application programming interface and graphical interface. The integration platform can integrate existing systems and information sources of the enterprise to ensure that the developed software is highly reusable. The basic capabilities of the integration platform comprise interconnection (opening up the connectivity of applications), data modeling and data conversion, and process modeling and execution (collaboration and even reengineering of business processes between applications, such as business closed loops). For example, the integration platform may connect instant messaging applications and information sets, allowing users to operate and edit information in the information set during the set.

In this embodiment, the workflow may refer to the automation of part or all of a business process in a computer application environment. It is an abstract and general description of the work process and the business rules between various operation steps. In computers, the workflow is part of computer-supported collaborative work, which is a general study of how a group can achieve collaborative work with the help of computers. The main problem which the workflow mainly solves is to use computers to automatically transfer documents, information or tasks among a plurality of participants according to certain predetermined rules in order to achieve a certain business goal. For example, the workflow is a group of tasks organized to complete a certain business process. It defines the triggering sequence and triggering conditions of the tasks. Each task may be completed by one or more software systems or by one or a group of people, and may further be completed by one or more people in collaboration with the software system.

The integration platform may provide enterprise users with business function services corresponding to the information set in the session scenario of instant messaging applications. The set of information is a set of information corresponding to the enterprise user, and the set of information may comprise information related to the enterprise user. The carrier of the set of information may be an online table.

The process in which the integration platform provides enterprise users with information set services corresponding to the consumer session in the session scenario of instant messaging applications may be divided into two stages, namely a service preparation stage and a service provision stage. The process in the service provision stage is the process in which the workflow executes the method for information processing according to this embodiment. The service preparation stage will be described in detail below.

Business users first need to create a chat robot. An initial robot may be created on a robot creation platform. Then, the initial robot is configured with configuration permissions that are related to the business capabilities corresponding to the specified set of information to be provided by the workflow in the session scenario. The robot creation platform may be a low-code platform, and the creator may create the initial robot by using the low-code platform in a visual way and configure the initial robot with the aforementioned configuration permissions. The creator may be an employee of the enterprise user.

After creating the chat robot, the chat robot is published, so that instant messaging applications and integration platforms may find the chat robot.

Afterwards, the creator may establish an association relationship between the chat robot and the workflow based on the integration platform. The workflow has been pre-downloaded to the server corresponding to the enterprise client, and the server has the integration platform pre-installed. Specifically, the creator may enter the identification information of the chat robot through the connection management interface provided by the workflow through the client of the integration platform. The identification information of the chat robot comprises: a robot identification and a robot key. The corresponding integration platform obtaining the chat robot identification and robot key is equivalent to obtaining the chat robot, where the robot identification and robot key are generated during the process of creating the chat robot.

Then, the integration platform establishes the association relationship between the chat robot and the workflow in response to a create and connect request generated by the creator triggering a create and connect control.

Afterwards, the creator enters the configuration information for the workflow in the information configuration interface provided for the workflow provided by the client of the integration platform. The configuration information comprises an access address link corresponding to the target information set, and may further comprise the chat robot's identification information (such as the robot identification and robot key of the chat robot), the configuration whether to automatically create the session menu (that is, whether to automatically create the session menu after entering the session, where “Y” is selected to automatically create), and configuration information (such as the session menu configuration information, query configuration information and the like to be mentioned later) related to the business capabilities corresponding to the specified set of information and to be provided by the workflow in the session scenario.

After the creator determines that the configuration for the workflow is completed based on the configuration requirements of the workflow, the creator will trigger an installation request for the workflow in an installation interface for the workflow provided by the client of the integration platform. Correspondingly, the integration platform will install workflow on the server corresponding to the enterprise customer. At this point, the workflow is associated with the chat robot and configured with a target information set.

Later, in order to ensure that the workflow can provide data business services and business function services corresponding to the session-related information set in the session scenario of the instant messaging application, a callback address of the workflow may further be obtained through the integration platform. The callback address is an address which is formed after the workflow is installed on the integration platform and which can be called back to the workflow.

Then, the creator subscribes to a designated event of the chat robot (such as a chat robot) for the workflow based on the callback address. Specifically, the creator copies the callback address from a message processing page provided by the workflow on the client of the integration platform, where the creator can find the callback address by triggering the “URL trigger” on the message processing page and entering a setting area of the “URL trigger”. Then, the callback address is pasted into a specified location of the chat robot's request address configuration interface (the interface provided by the robot creation platform), and an event addition operation is triggered on the request address configuration interface to add the specified event of the chat robot, thereby configuring callback address is configured as the request URL of the specified event of the chat robot. The corresponding relationship between the event identifier of the specified event of the chat robot and the callback address of the workflow is created and stored, so that the workflow subscribes to the specified event of the chat robot successfully. Afterwards, any event in the chat robot's specified event is triggered, and the workflow can be called back through the callback address of the workflow, so that the workflow can provide business functions corresponding to the corresponding information set for the session scenario. The specified event may include, for example, a robot entering a session, a robot being removed from a session, and a robot receiving a message. Each specified event requires corresponding permissions.

The chat robot may further be configured to feedback messages in the session of the instant messaging application through message cards. Correspondingly, the callback address needs to be configured as the message card request URL of the chat robot (in the message card information configuration interface provided by the robot creation platform), so that in the session, after the chat robot receives the trigger operation of the message in the form of a message card sent by the session member (chat robot), the request corresponding to the trigger operation may be called back to the workflow through the callback address. The workflow provides corresponding business functions for sessions.

After the above configuration, the information set may be configured for the workflow, the association relationship between the chat robot and the workflow may be established, the association relationship between the chat robot and the information collection may be established accordingly, and the specified event of the chat robot may be subscribed to the workflow successfully.

Later, in the robot's security settings interface provided by the robot creation platform, the callback address may be configured as the chat robot's redirect URL (Uniform Resource Locator), where the redirect URL is added as a login-free authorization code jump address.

In a web browser, the callback address is accessed to enter the authorization interface that instructs the chat robot to log in to the instant messaging application without authorization. It may be understood that the redirect URL of the chat robot is configured as the callback address of the workflow, instructing the chat robot to log in to the instant messaging application without authorization, that is, instructing the workflow to log in to the instant messaging application without authorization. The authorization interface includes authorization controls. Subsequently, in response to the authorization instruction, the chat robot and workflow are authorized to log in to the instant messaging application without authorization.

In one implementation, the set of information comprises an online table. Correspondingly, in response to the authorization instruction, the workflow further sends a table initialization request to a first online table. Correspondingly, in response to the table initialization request, the first online table creates a first sub-table in the first online table. The first sub-table may be used to store the workflow as a corresponding session (the session with the aforementioned predetermined control or the session where the chat robot is located) and information related to the business functions corresponding to the information set (including at least part of the content in the information set).

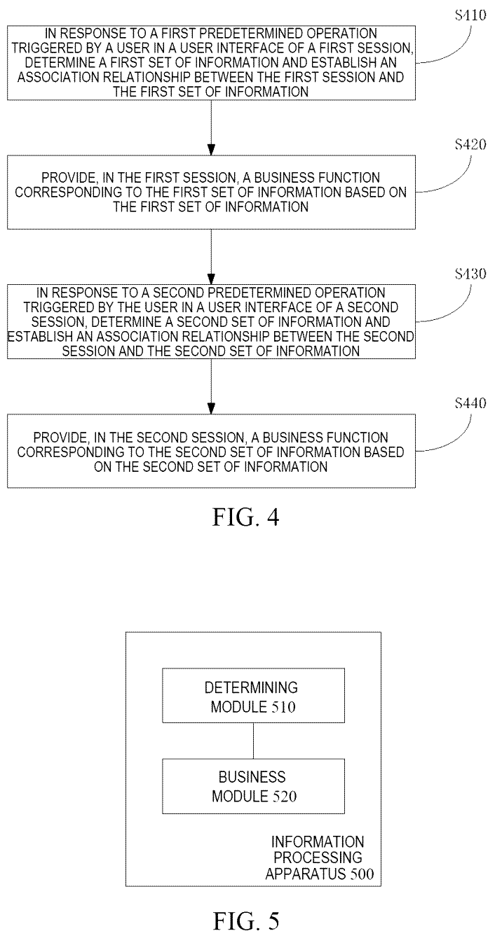

With reference to FIG. 4, description is presented below to a method for information processing according to another embodiment of the present application.

According to this embodiment, the method for information processing comprises:

At S410, in response to a first predetermined operation triggered by a user in a user interface of a first session, a first set of information is determined and an association relationship between the first session and the first set of information is established.

At S420, in the first session, a business function corresponding to the first set of information is provided based on the first set of information.

At S430, in response to a second predetermined operation triggered by the user in a user interface of a second session, a second set of information is determined and an association relationship between the second session and the second set of information is established.

At S440, in the second session, a business function corresponding to the second set of information is provided based on the second set of information.

According to this embodiment, the user may start a plurality of sessions at the same time and perform different operations for each session to call different information sets and implement different business functions. In daily work, users often need to start a plurality of sessions at the same time and chat with different objects or groups, and each session has different work characteristics. By allowing users to call different information sets or data for different sessions and thereby enable different business functions, users can use the method for information processing of this embodiment in a more diversified manner, and enter and utilize different session scenarios in a more targeted manner.

In this embodiment, S410 and S420 correspond to S110 and S140 of the embodiment in FIG. 1. For details, please refer to the relevant description of the embodiment in FIGS. 1. S430 and S440 are described in detail below.

In this embodiment, the second session may refer to another session function, window, interface or other form of carrier that is different from the first session. In this embodiment, the second set of information may refer to another set of information that is different from the first set of information, and has an association relationship with the second session.

As an example, the business function corresponding to the first set of information and the business function corresponding to the second set of information are of different types.

According to this example, different sessions correspond to different sets of information, and the business functions corresponding to these sets of information are also different. This is the most common usage scenario for users who need to start a plurality of sessions. By providing different types of business functions for different sessions, specialized business operations can be performed based on the characteristics of different sessions to better meet the user's collaboration purposes.

In other words, the difference between the first set of information and the second set of information is that their corresponding business functions are different, and the two business functions belong to different types. For example, the first set of information corresponds to the information query function, and the second set of information corresponds to the session menu function.

As an example, the business function corresponding to the first set of information and the business function corresponding to the second set of information are of a same type but for different information contents.

According to this example, by providing different information sets with the same type of business functions but different information contents, users can be allowed to fine-tune and control different information contents by establishing different sessions, making it easier for users to plan and determine what information content can be opened to which sessions or session members, so as to perform richer and more diverse information management and work collaboration.

In other words, the difference between the first set of information and the second set of information is not that they correspond to different types of business functions. Their corresponding business functions belong to the same type, but the information content targeted by the two corresponding business functions is different. For example, both the first and second sets of information correspond to the query function of customer information, but the first set of information corresponds to the query function of Chinese customer information, and the second set of information corresponds to the query function of American customer information.

As an example, the first set of information comprises one or more sub-tables of the first online table, and the first sub-table of the first online table further stores information about an association relationship between a second session and a second set of information, the second set of information comprising one or more sub-tables of the first online table.

According to this example, by realizing the information set and the association storing the session and the information set in the form of a sub-table of the online table, the information can be summarized, organized and edited in the simplest way as far possible. The table is simple and clear, and information is easy to display and modify.

In this embodiment, sub-tables may refer to a plurality of small tables included in an online table. These small tables record part of the information of the online table, and all small tables together constitute the online table. In this embodiment, the first sub-table may be one of the sub-tables of the first online table, specifically used to store information about the association relationship between the second session and the second set of information.

In this embodiment, the first set of information comprises one or more sub-tables of the first online table, which may mean that part of the sub-tables in the first online table constitute the first set of information, or may mean that all of the sub-tables of the first online table constitute the first set of information. In this embodiment, the second set of information comprises one or more sub-tables of the first online table, which may mean that part of the sub-tables in the first online table constitute the second set of information, or may mean that all of the sub-tables of the first online table constitute the second set of information. In the latter case, the first set of information coincides (at least partially) with the second set of information.

A method for information processing according to another embodiment of the present application will be described below. This embodiment is basically the same as the embodiment in FIG. 1. The difference is that in this method, the session may refer to a communication scenario provided by the email software.

At this point, the user interface may refer to an email writing or receiving interface. The predetermined operation triggered by the user in the user interface of the session may refer to the email user clicking a certain button in the writing interface, or entering a specific symbol to introduce a specific function. In the email scenario, the information set may be tables, data, text or databases stored in the email client or server. Establishing an association relationship between the session and the information set may refer to establishing an association relationship between the currently composed email and the corresponding database, so that the data in the database may be conveniently called during the email drafting process to explain problems or enrich the email content. The business function corresponding to the information set may be a query function for tables or databases. When the user clicks a certain button, a query dialog box pops up for the user to enter query keywords. Alternatively, the business function corresponding to the information set may be a session menu function. For example, when the user enters a special symbol, a line of menus appears on the email text drafting interface for the user to click to quickly input or obtain specific information. The option content of the menu or the information linked to the option may correspond exactly to the information set.

FIG. 5 shows a schematic structural diagram of an apparatus for information processing according to an embodiment of the present application.

According to this embodiment, the apparatus 500 for information processing comprises: a determining module 510 configured to, in response to a first predetermined operation triggered by a user in a user interface of a first session, determine a first set of information and establishing an association relationship between the first session and the first set of information; and a business module 520 configured to provide, in the first session, a business function corresponding to the first set of information based on the first set of information.

In one embodiment, the determining module 510 is further configured to: in response to the first predetermined operation triggered by the user in the user interface of the first session, determine a target object pointed to by the first predetermined operation, and determine a set of information associated with the target object as the first set of information.

In one embodiment, the first predetermined operation comprises: an operation of adding a predetermined chat robot as a member of the first session, the target object comprising the predetermined chat robot. Or the first predetermined operation comprises: triggering a predetermined control in the first session, the target object comprising the predetermined control.

In one embodiment, the apparatus 500 for information processing further comprises: a second determining module configured to, in response to a second predetermined operation triggered by the user in a user interface of a second session, determine a second set of information and establish an association relationship between the second session and the second set of information; a second business module configured to provide, in the second session, a business function corresponding to the second set of information based on the second set of information, the business function corresponding to the first set of information and the business function corresponding to the second set of information are of different types, or the business function corresponding to the first set of information and the business function corresponding to the second set of information are of a same type but for different information contents.

In one embodiment, the first set of information comprises a plurality of subsets of information corresponding to a plurality of business functions, and the business module 520 is further configured to: provide, in the first session, a plurality of business functions corresponding to the plurality of subsets of information.

In one embodiment, the determining module 510 is further configured to: store information about the association relationship between the first session and the first set of information in a first sub-table of a first online table.

In one embodiment, the first set of information comprises one or more sub-tables of the first online table, and the first sub-table of the first online table further stores information about an association relationship between a second session and a second set of information, the second set of information comprising one or more sub-tables of the first online table.

In one embodiment, the first set of information comprises session menu configuration information; the business module 520 is further configured to: create a session menu in the first session based on the session menu configuration information; and/or the first set of information comprises a predetermined data set; the business module 520 is further configured to: provide a service for querying the predetermined data set in the first session.

In one embodiment, in response to that the first set of information comprises the session menu configuration information, the apparatus 500 for information processing further comprises: an update module configured to, in response to receiving an operation for modifying the menu configuration information, update the session menu in the first session accordingly.

In one embodiment, in response to that the first set of information comprises the session menu configuration information, the first predetermined operation comprises: an operation for adding a predetermined chat robot as a member of the first session, and the apparatus 500 for information processing further comprises: a deleting module configured to, in response to deleting the predetermined chat robot from the first session, remove the session menu from the first session, and delete the association relationship between the first session and the first set of information.

In one embodiment, if the first set of information comprises the predetermined data set, the business module 520 is further configured to: in response to the user inputting a message comprising a predetermined symbol and a query keyword in the first session, obtain a query result matching the query keyword from the predetermined data set, and feedback the query result into the first session.

In one embodiment, the predetermined symbol comprises a symbol referring to a predetermined chat robot; and the apparatus 500 for information processing further comprises: an adding module configured to add the predetermined chat robot as a member of the first session, and wherein the apparatus 500 for information processing further comprises: a second deleting module configured to, in response to deleting the predetermined chat robot from the first session, delete the association relationship between the first session and the first set of information.

In one embodiment, the business module 520 is further configured to: display the query result to all session members in the first session; or display the query result to a portion of the session members in the first session, wherein the portion of the session members comprises the user and at least one further user; or display the query result only to the user in the first session.

In one embodiment, the business module 520 is further configured to: obtain display style configuration information of the query result corresponding to the first session; and send a query feedback message comprising at least a portion of the query result in the first session based on the query result and the display style configuration information of the query result corresponding to the first session.

In one embodiment, the business module 520 is further configured to: send a query response message in the first session, the query response message comprising an interactive control for further adjusting a query scope; and in response to the user's operation of adjusting the query scope based on the interactive control, obtain the query result in the user-adjusted query scope and send the query result in the first session.

In one embodiment, the interactive control comprises: a data source selection control for selecting from a plurality of data sources, and/or a setting control of a filtering condition, the filtering condition comprising at least one of: a data record creator, a data record creation time, or a value of a field comprised in the data record.

In one embodiment, if the first set of information comprises the session menu configuration information and the predetermined data set, the session menu created in the first session comprises a first menu item providing the user with an interface for inputting information to the predetermined data set.

In one embodiment, the first menu item is bound to an access address of the predetermined data set, and the first menu item outputs to the user a page for inputting information to the predetermined data set in response to the user accessing the first menu item.

For details and advantages of the apparatus for information processing device, reference may be made to the above relevant description of the embodiments in FIGS. 1 and 2.

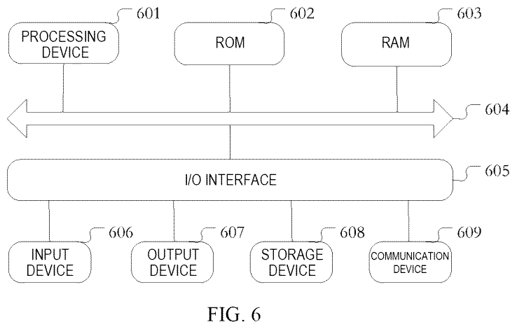

With reference to FIG. 6 below, this figure shows a structural schematic diagram of an electronic device (e.g., the server in FIG. 1) 600 which is applicable to implement the embodiments of the present disclosure. The server shown in FIG. 6 is merely an example and should not be construed as bringing any restriction on the functionality and usage scope of the embodiments of the present disclosure.

As shown in FIG. 6, the electronic device 600 may comprises a processing unit (e.g., a central processor, a graphics processor) 601 which is capable of performing various appropriate actions and processes in accordance with programs stored in a read only memory (ROM) 602 or programs loaded from a storage unit 608 to a random access memory (RAM) 603. In the RAM 603, there are also stored various programs and data required by the electronic device 600 when operating. The processing unit 601, the ROM 602 and the RAM 603 are connected to one another via a bus 604. An input/output (I/O) interface 605 is also connected to the bus 604.

Usually, the following units may be connected to the I/O interface 605: an input unit 606 including a touch screen, a touch pad, a keyboard, a mouse, a camera, a microphone, an accelerometers, a gyroscope, or the like; an output unit 607, such as a liquid-crystal display (LCD), a loudspeaker, a vibrator, or the like; a storage unit 608, such as a magnetic tape, a hard disk or the like; and a communication unit 609. The communication unit 609 allows the electronic device to perform wireless or wired communication with other device so as to exchange data with other device. While FIG. 6 shows the electronic device with various units, it should be understood that it is not required to implement or have all of the illustrated units. Alternatively, more or less units may be implemented or exist. Each block shown in FIG. 6 may represent one unit or a plurality of units as needed.

Specifically, according to the embodiments of the present disclosure, the procedures described with reference to the flowchart may be implemented as computer software programs. For example, the embodiments of the present disclosure comprise a computer program product that comprises a computer program embodied on a computer-readable medium, the computer program including program codes for executing the method shown in the flowchart. In such an embodiment, the computer program may be loaded and installed from a network via the communication unit 609, or installed from the storage unit 608, or installed from the ROM 602. The computer program, when executed by the processing unit 601, perform the above functions defined in the method of the embodiments of the present disclosure.

The embodiments of this specification further provide a computer-readable storage medium storing a computer program thereon, the computer program, when executed in a computer, causing the computer to perform the method described in this specification.

It is noteworthy that the computer readable medium of the present disclosure can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

The above computer readable medium may be included in the above-mentioned electronic device; and it may also exist alone without being assembled into the electronic device. The computer readable medium carries one or more programs which, when executed by the server, cause the electronic device to: in response to a first predetermined operation triggered by a user in a user interface of a first session, determine a first set of information and establishing an association relationship between the first session and the first set of information; and provide, in the first session, a business function corresponding to the first set of information based on the first set of information.

Computer program codes for carrying out operations of the present disclosure may be written in one or more programming languages, including without limitation to, an object-oriented programming language such as Java, Smalltalk, C++ or the like, and conventional procedural programming languages, such as the “C” programming language or similar programming languages. The program codes may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Each embodiment in this specification is described in a progressive manner. The same and similar parts between the various embodiments may be referred to each other. Each embodiment focuses on its differences from other embodiments. In particular, storage media and computing device embodiments are described simply because they are basically similar to method embodiments. For relevant information, reference may be made to the description of method embodiments.

Those skilled in the art should realize that in one or more of the above examples, the functions described in the embodiments of the present invention may be implemented by hardware, software, firmware or any combination thereof. When implemented using software, these functions may be stored on or transmitted over as one or more instructions or codes on a computer-readable medium.

The above detailed description further explains in detail the objective, technical solution and beneficial effects of the embodiments of the present invention. It should be understood that what has been described above is merely specific implementations of the embodiments, and is not used to limit the protection scope of the present invention. Any modifications, equivalent substitutions, and improvements made on the basis of the technical solution of the present invention should all be included in the protection scope of the present invention.

I/we claim:

1. A method for information processing, comprising:
in response to a first predetermined operation triggered by a user in a user interface of a first session, determining a first set of information and establishing an association relationship between the first session and the first set of information; and
providing, in the first session, a business function corresponding to the first set of information based on the first set of information.

2. The method of claim 1, wherein the in response to a first predetermined operation triggered by a user in a user interface of a first session, determining a first set of information comprises:
in response to the first predetermined operation triggered by the user in the user interface of the first session, determining a target object pointed to by the first predetermined operation, and determining a set of information associated with the target object as the first set of information.

3. The method of claim 2, wherein:
the first predetermined operation comprises: an operation of adding a predetermined chat robot as a member of the first session, the target object comprising the predetermined chat robot, or
the first predetermined operation comprises: triggering a predetermined control in the first session, the target object comprising the predetermined control.

4. The method of claim 1, further comprising:
in response to a second predetermined operation triggered by the user in a user interface of a second session, determining a second set of information and establishing an association relationship between the second session and the second set of information;
providing, in the second session, a business function corresponding to the second set of information based on the second set of information,
the business function corresponding to the first set of information and the business function corresponding to the second set of information are of different types, or the business function corresponding to the first set of information and the business function corresponding to the second set of information are of a same type but for different information contents.

5. The method of claim 1, wherein the first set of information comprises a plurality of subsets of information corresponding to a plurality of business functions, and the providing in the first session a business function corresponding to the first set of information comprises:
providing, in the first session, a plurality of business functions corresponding to the plurality of subsets of information.

6. The method of claim 1, wherein the establishing an association relationship between the first session and the first set of information comprises:
storing information about the association relationship between the first session and the first set of information in a first sub-table of a first online table.

7. The method of claim 6, wherein the first set of information comprises one or more sub-tables of the first online table, and the first sub-table of the first online table further stores information about an association relationship between a second session and a second set of information, the second set of information comprising one or more sub-tables of the first online table.

8. The method of claim 1, wherein:
the first set of information comprises session menu configuration information, and the providing a business function corresponding to the first set of information in the first session based on the first set of information comprises: creating a session menu in the first session based on the session menu configuration information, and/or
the first set of information comprises a predetermined data set, and the providing a business function corresponding to the first set of information in the first session based on the first set of information comprises: providing a service for querying the predetermined data set in the first session.

9. The method of claim 8, wherein in response to that the first set of information comprises the session menu configuration information, the method further comprises:
in response to receiving an operation for modifying the menu configuration information, updating the session menu in the first session accordingly.

10. The method of claim 8, wherein in response to that the first set of information comprises the session menu configuration information, the first predetermined operation comprises: an operation for adding a predetermined chat robot as a member of the first session, and
wherein the method further comprises: in response to deleting the predetermined chat robot from the first session, removing the session menu from the first session, and deleting the association relationship between the first session and the first set of information.

11. The method of claim 8, wherein if the first set of information comprises the predetermined data set, the providing a service for querying the predetermined data set in the first session comprises:
in response to the user inputting a message comprising a predetermined symbol and a query keyword in the first session, obtaining a query result matching the query keyword from the predetermined data set, and feeding back the query result into the first session.

12. The method of claim 11, wherein the predetermined symbol comprises a symbol referring to a predetermined chat robot, and before providing a service for querying the predetermined data set in the first session, the method further comprises: adding the predetermined chat robot as a member of the first session, and
wherein the method further comprises: in response to deleting the predetermined chat robot from the first session, deleting the association relationship between the first session and the first set of information.

13. The method of claim 11, wherein the feeding back the query result into the first session comprises:
displaying the query result to all session members in the first session; or
displaying the query result to a portion of the session members in the first session, wherein the portion of the session members comprises the user and at least one further user; or
displaying the query result only to the user in the first session.

14. The method of claim 11, wherein the feeding back the query result into the first session comprises:
obtaining display style configuration information of the query result corresponding to the first session; and
sending a query feedback message comprising at least a portion of the query result in the first session based on the query result and the display style configuration information of the query result corresponding to the first session.

15. The method of claim 11, wherein the feeding back the query result into the first session comprises:
sending a query response message in the first session, the query response message comprising an interactive control for further adjusting a query scope; and
in response to the user's operation of adjusting the query scope based on the interactive control, obtaining the query result in the user-adjusted query scope and sending the query result in the first session.

16. The method of claim 15, wherein the interactive control comprises:
a data source selection control for selecting from a plurality of data sources, and/or
a setting control of a filtering condition, the filtering condition comprising at least one of: a data record creator, a data record creation time, or a value of a field comprised in the data record.

17. The method of claim 8, wherein if the first set of information comprises the session menu configuration information and the predetermined data set, the session menu created in the first session comprises a first menu item providing the user with an interface for inputting information to the predetermined data set.

18. The method of claim 17, wherein the first menu item is bound to an access address of the predetermined data set, and the first menu item outputs to the user a page for inputting information to the predetermined data set in response to the user accessing the first menu item.

19. A non-transitory computer-readable storage medium, with a computer program stored thereon, when the computer program is executed in a computer, causing the computer to perform a method for information processing, the method comprising:
in response to a first predetermined operation triggered by a user in a user interface of a first session, determining a first set of information and establishing an association relationship between the first session and the first set of information; and
providing, in the first session, a business function corresponding to the first set of information based on the first set of information.

20. An electronic device, comprising a memory and a processor, the memory storing executable code, when the executable code is executed by the processor, implementing a method for information processing, the method comprising:
in response to a first predetermined operation triggered by a user in a user interface of a first session, determining a first set of information and establishing an association relationship between the first session and the first set of information; and
providing, in the first session, a business function corresponding to the first set of information based on the first set of information.
